(19) United States
(12) Patent Application Publication
(10) Pub. No.: US 2026/0340623 A1
(43) Pub. Date: Oct. 29, 2026

(54) SYSTEMS AND METHODS FOR CONTACT AND CONTACTLESS PAYMENTS

(71) Applicant: VeriFone, Inc., Wilmington, DE (US)

(72) Inventors: James Mo, Taipei City (TW); Kevin Liu, Taipei City (TW)

(73) Assignee: VeriFone, Inc., Wilmington, DE (US)

(21) Appl. No.: 19/106,066

(22) PCT Filed: Aug. 30, 2022
(86) PCT No.: PCT/US2022/075650

§ 371 Date: Feb. 24, 2025

(51) Int. Cl. G06Q 20/34

(52) U.S. Cl. CPC G06Q 20/352

(57) ABSTRACT

A payment terminal including a card insertion slot, an antenna, and an electromagnetic shield is provided. The card insertion slot is configured to capture card information stored on a payment card. The card information may be stored on a chip embedded in the payment card. The antenna is configured to receive the card information wirelessly transmitted by the payment card, such as via NFC. The payment card may be a dual interface card. The electromagnetic shield is arranged between the antenna and the card insertion slot and includes a ferrite layer and a paramagnetic metal layer separated by a gap, such as 2 millimeters. A processor is coupled to the card insertion slot and the antenna to receive and process the captured card information.

### FIELD OF THE DISCLOSURE

The present disclosure is directed generally to systems and methods for contact and contactless payments.

### BACKGROUND

State-of-the-art payment terminals are typically configured for both contact and contactless payment. In contact payments, a customer inserts their payment card (such as a credit card or debit card) into a payment terminal. Similarly, to facilitate contactless payments, the customer holds their payment card near (such as within a few centimeters) the payment terminal. Given the overall size of the payment terminal, the components facilitating contact and contactless payments are often arranged proximate to each other. Accordingly, in some instances, when a customer inserts their payment card for a contact payment, a contactless payment may be triggered, interrupting the contact payment process.

Some payment terminals address this interruption by disabling contactless payment components upon detection of the insertion of the payment card. However, this solution can be limited by the high speed of the contactless payment; if a customer slowly inserts their payment card, the payment terminal may complete the contactless payment before detecting the insertion of the payment card. Further, some payment terminals have used various types of shielding to isolate contact payment components from the contactless payment components. However, these shielding solutions often fail to balance adequate shielding with allowing the contactless payment components to wirelessly capture card information transmitted by the payment card. Accordingly, there is a need for a payment terminal which enables contact payment without interruption from contactless payment components, while still enabling contactless payments when desired.

### SUMMARY OF THE DISCLOSURE

The present disclosure is generally directed to systems and methods for contact and contactless payments. In particular, a payment terminal having a card insertion slot for contact payments, an antenna for contactless payments, and an electromagnetic shield arranged between the card insertion slot and the antenna, is provided. The card insertion slot is configured to physically receive a payment card, such as a credit card or debit card, and capture card information from the payment card. The card insertion slot is preferably configured as a chip reader to capture card information from a chip embedded in the payment card. The card information includes data required to facilitate a payment using an account corresponding to the payment card. Accordingly, card information may include a personal account number (PAN), a customer verification value (CVV), an expiration date, etc. Further, the card insertion slot may be communicatively coupled to a processor configured to receive and process the card information captured from the payment card.

The antenna is configured to wirelessly capture card information from the payment card when the payment card is positioned proximate (such as a few centimeters) to the antenna. In some examples, the payment card and the antenna may be configured to transmit and capture, respectively, the card information via near field communication (NFC) or radio frequency identification (RFID) protocols. The antenna may be positioned proximate to the card insertion slot due to the physical layout requirements of the payment terminal. Further, the antenna may be also communicatively coupled to the processor configured to receive and process the card information.

The electromagnetic shield includes both a ferrite layer and a paramagnetic metal layer. The ferrite layer is proximate to the antenna, and is separated from the paramagnetic metal layer by a gap. The ferrite layer compensates for antenna transmission and reception power losses caused by the paramagnetic metal layer, while the paramagnetic metal layer further suppresses magnetic leakage through the ferrite. Further, the combination of the ferrite layer and the paramagnetic metal layer may provide better isolation than the ferrite layer alone. The size of the gap between the ferrite layer and the paramagnetic metal layer may be tuned to balance the antenna power required to facilitate contactless payments while providing sufficient isolation between the antenna and the card insertion slot. In some examples, the gap may be approximately 2 mm resulting in a reference coupling between the antenna and the card insertion slot of 8 millivolts. In some examples, the ferrite layer may be stainless steel, while the paramagnetic metal layer may be aluminum. In some further examples, both the ferrite and paramagnetic metal layers may be thinner than the gap.

Generally, in one aspect, a payment terminal is provided. The payment terminal includes a card insertion slot. The card insertion slot is configured to capture card information stored on a payment card. According to an example, the card insertion slot is configured to capture the card information from a chip embedded in the payment card. The payment card may be a dual interface card.

The payment terminal further includes an antenna. The antenna is configured to receive the card information wirelessly transmitted by the payment card. The antenna may be an NFC antenna.

The payment terminal further includes an electromagnetic shield. The electromagnetic shield is arranged between the antenna and the card insertion slot. The electromagnetic shield includes a ferrite layer and a paramagnetic metal layer separated by a gap. According to an example, the gap separating the ferrite layer from the paramagnetic metal layer is approximately 2 millimeters.

According to an example, the ferrite layer is adjacent to the antenna. According to a further example, the ferrite layer is thinner than the gap. The ferrite layer may include aluminum.

According to an example, the paramagnetic metal layer is thinner than the gap. The paramagnetic metal layer may include stainless steel. According to a further example, at least a portion of the ferrite layer is parallel to at least a portion of the paramagnetic metal layer.

According to an example, the payment terminal further includes a processor. The processor is configured to receive the card information from the card insertion slot or the antenna.

According to an example, the card insertion slot is arranged proximate to the antenna.

According to an example, a reference coupling measured between the card insertion slot and the antenna is less than or equal to eight millivolts.

Generally, in another aspect, a method for manufacturing a payment terminal is provided. The method includes configuring a card insertion slot to capture card information stored on a payment card. The card insertion slot may be configured to capture the card information from a chip embedded in the payment card.

The method further includes configuring an antenna to receive card information wirelessly transmitted by the payment card. According to an example, the antenna is an NFC antenna.

The method further includes arranging an electromagnetic shield between the antenna and the card insertion slot. The electromagnetic shield includes a ferrite layer and a paramagnetic metal layer separated by a gap. The gap separating the ferrite layer from the paramagnetic metal layer may be approximately 2 millimeters.

According to an example, the ferrite layer may be thinner than the gap. Further, the paramagnetic metal layer may also be thinner than the gap.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a graph showing various measured reference coupling voltages for various potential shielding arrangements, according to aspects of the present disclosure.

FIG. 2 is a top view of a payment terminal, according to aspects of the present disclosure.

FIG. 3 is a top view of a payment card, according to aspects of the present disclosure.

FIG. 4 is a cross-sectional view of a payment terminal, according to aspects of the present disclosure.

FIG. 5 is an isometric view of a payment terminal, according to aspects of the present disclosure.

FIG. 6 is an isometric view of the payment terminal of FIG. 5 with the upper housing portion and the keypad removed, according to aspects of the present disclosure.

FIG. 7 is an isometric view of the payment terminal of FIG. 6 with the antenna removed, according to aspects of the present disclosure.

FIG. 8 is an isometric view of the payment terminal of FIG. 7 with the ferrite layer removed, according to aspects of the present disclosure.

FIG. 9 is a further isometric view of internal components of a payment terminal, according to aspects of the present disclosure.

FIG. 10 is a functional block diagram of a payment terminal, according to aspects of the present disclosure.

FIG. 11 is a flow chart of a method for manufacturing a payment terminal, according to aspects of the present disclosure.

### DETAILED DESCRIPTION OF EMBODIMENTS

The present disclosure is generally directed to systems and methods for contact and contactless payments. In particular, a payment terminal having a card insertion slot for contact payments, an antenna for contactless payments, and an electromagnetic shield arranged between the card insertion slot and the antenna, is provided. The card insertion slot is configured to physically receive a payment card, such as a credit card or debit card, and capture card information from the payment card. The antenna is configured to wirelessly capture card information from the payment card when the payment card is positioned proximate (such as a few centimeters) to the antenna. In some examples, the payment card and the antenna may be configured to transmit and capture, respectively, the card information via near field communication (NFC) or radio frequency identification (RFID) protocols. The electromagnetic shield includes both a ferrite layer and a paramagnetic metal layer. The ferrite layer is proximate to the antenna, and is separated from the paramagnetic metal layer by a gap. The size of the gap between the ferrite layer and the paramagnetic metal layer may be tuned to balance the antenna power required to facilitate contactless payments while providing sufficient isolation between the antenna and the card insertion slot. In some examples, the gap may be approximately 2 mm resulting in a reference coupling between the antenna and the card insertion slot of 8 millivolts.

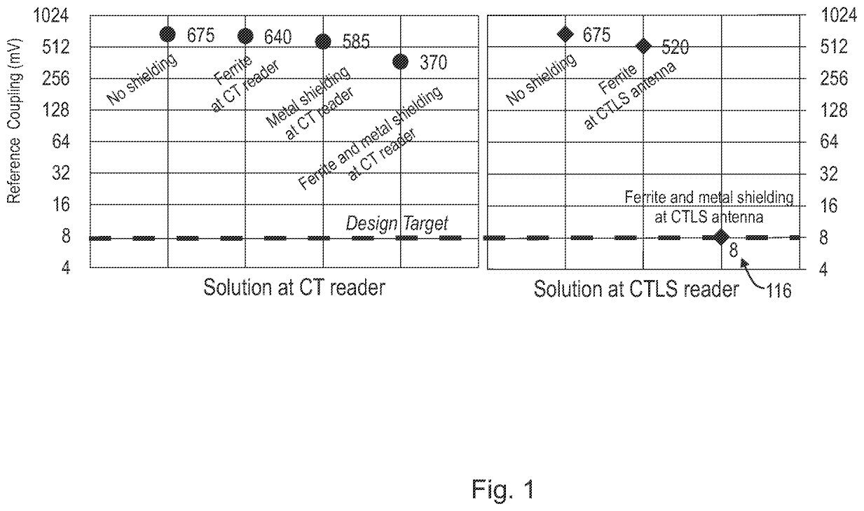

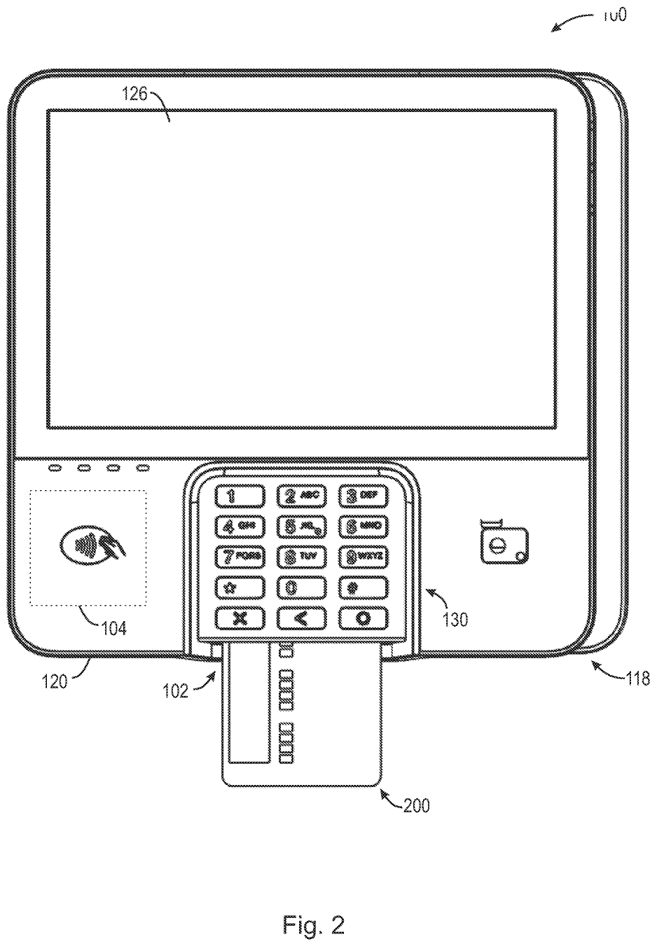

FIG. 1 is a graph showing various measured reference coupling 116 voltages for various potential shielding solutions. In particular, FIG. 1 shows reference coupling 116 measured between a card insertion slot 102 and an antenna 104 of an existing payment terminal 100 (see FIG. 2). The reference coupling measurements 116 are divided into two categories, shielding at the card insertion slot 102 (contact (CT) reader) or the antenna 104 (contactless (CTLS) reader). The overall design goal is to reduce reference coupling 116 as much as possible while still allowing the antenna 104 to transmit and receive data. In this example, the “design target” for the reference coupling 116 measurement is 8 millivolts. As seen on the left side of the graph, when no shielding is used, the reference coupling 116 is measured to be 675 millivolts. When ferrite is used at the card insertion slot 102, the reference coupling 116 slightly decreases to 640 millivolts. When metal shielding is used instead of ferrite, the reference couple 116 slightly decreases even further to 585 millivolts. When both ferrite and metal shielding are used, the reference coupling 116 decreased by more significant margin to 370 millivolts. However, even when using both ferrite and metal shielding, shielding solutions at the card insertion slot 102 do not meet the reference coupling 116 design goals.

On the right side of the graph, when ferrite is used at the antenna 104, the reference coupling 116 is reduced to 520 millivolts. Further, simply arranging metal shielding around the antenna 104 negatively impacts the transmission and receiving power such that the antenna 104 will fail to meet industry standards for contactless payment. In some examples, these standards are set by Europay, Visa, and Mastercard (EMV).

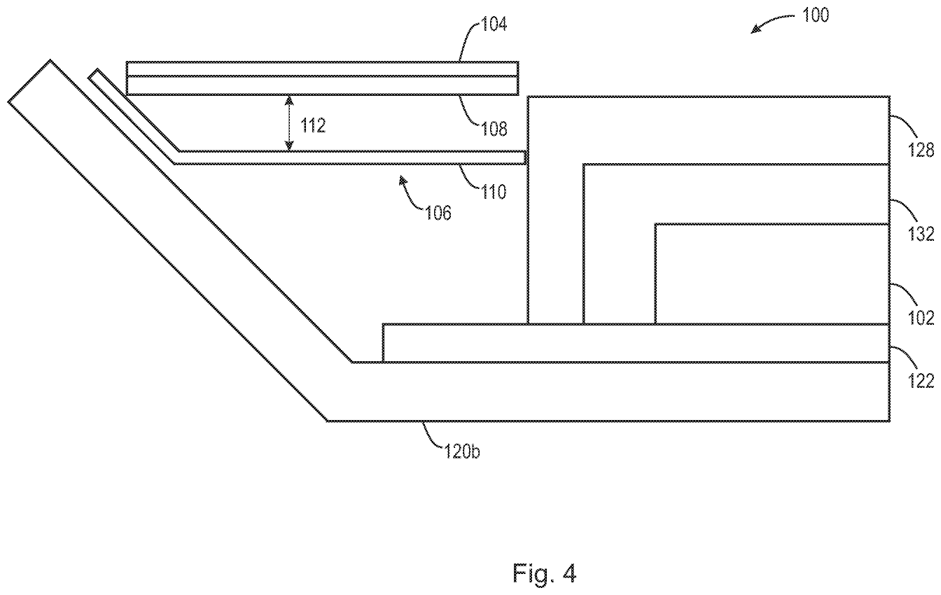

By using both ferrite and metal shielding, the reference coupling 116 significantly decreases to the design goal of 8 millivolts. However, in order to allow the antenna 104 to sufficiently transmit and receive wireless data, some amount of spacing is required between the antenna 104 and the metal shielding. This spacing will be defined in terms of a gap 112 (see FIG. 4) in subsequent sections of the disclosure. The ferrite compensates for power loss of the antenna 104 due to the metal shielding, and the metal shielding can further suppress magnetic leakage through the ferrite. In a preferred example, a paramagnetic metal can be used to provide even better isolation. Additionally, the dimensions of the gap 112 can be configured (tuned) to balance out the required antenna power with the desired isolation.

FIG. 2 is a top view of a payment terminal 100. The payment terminal 100 is a merchant-operated, customer-facing device. Broadly, the payment terminal 100 may be any device capable of processing a payment via a payment card 200, such as a credit card, debit card, gift card, etc. In the example of FIG. 2, the payment terminal 100 is configured to be physically mounted within a commercial establishment, such as in a checkout lane or a grocery store. The payment terminal 100 includes a card insertion slot 102 to receive the payment card 200 for contact payments, an antenna 104 to facilitate contactless payments, a magnetic stripe reader 118, a housing 120, a display 126, and a keypad 130. In other examples, the payment terminal 100 may be a portable device configured as a compact variation of the payment terminal 100 of FIG. 2, such as with a smaller display 126 or a keypad 130 with less keys. In further examples, the payment terminal 100 may be an even smaller portable device without the display 126 or keypad 130. Regardless of the variation, proper isolation between the card insertion slot 102 and the antenna 104 is required to prevent unwanted contactless payments upon insertion of the payment card 200.

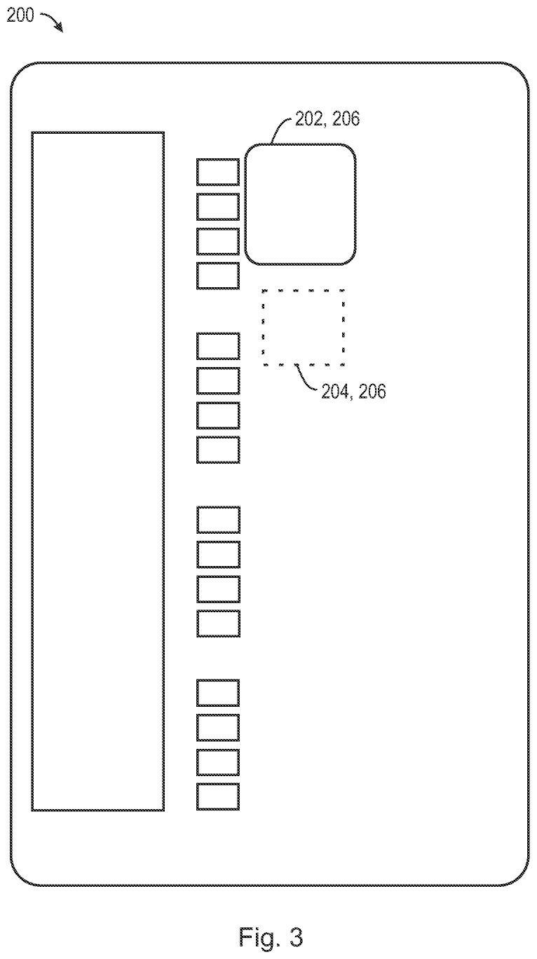

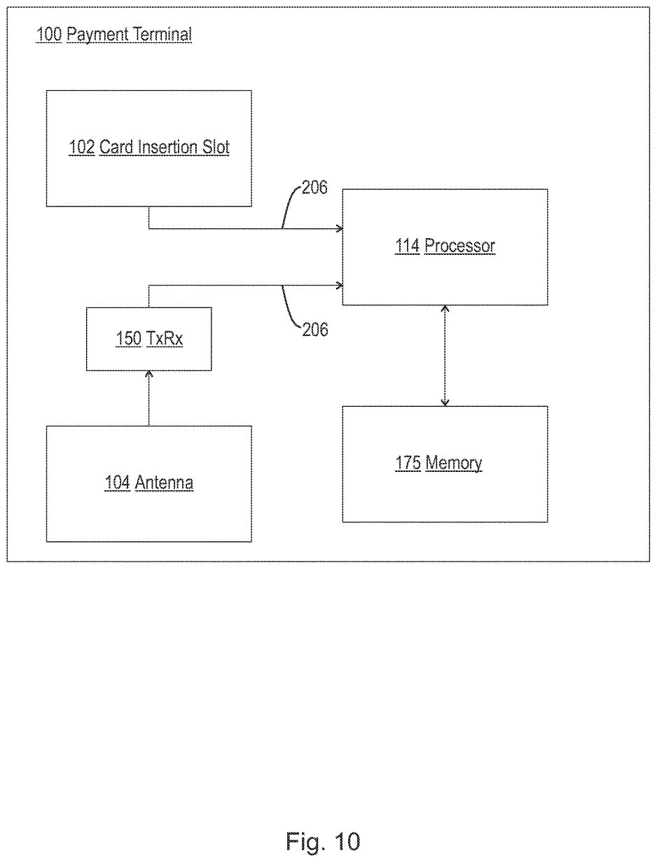

The card insertion slot 102 is configured to physically receive payment card 200. Preferably, the card insertion slot 102 includes (or is configured as) a chip reader to capture card information 206 stored in a chip 202 of the payment card 200. The payment card 200 and chip 202 are shown in more detail in FIG. 3. The card information 206 includes data required to facilitate a payment using an account corresponding to the payment card 200. Accordingly, card information 206 may include a personal account number (PAN), a customer verification value (CVV), an expiration date, etc. As shown in FIG. 10, the card insertion slot 102 may provide the captured card information 206 to a processor 114 of the payment terminal 100 for processing and/or storage in memory 175.

The antenna 104 is embedded within the housing 120 of the payment terminal 100. The antenna 104 is configured to receive wireless signals, such as radio frequency (RF) signals, transmitted by the payment card 200. The wireless signals may convey the same card information 206 captured by the card insertion slot 102. In the example of FIG. 2, an NFC icon is affixed to the housing 120 above the antenna 104. In NFC configurations, the antenna 104 of the payment card 200 transmits an RF signal configured to activate an antenna 204 of the payment card 200. The antenna 204 of the payment card 200 then transmits an RF signal conveying the card information, which is received by the antenna 104 of the payment terminal 100. In the example of an NFC configured payment card, the antenna 204 of the payment card 200 must be within 4 centimeters of the antenna 104 of the payment terminal 200 to receive the initial RF signal transmitted by the payment terminal 100. In some examples, the payment terminal 100 may include a first antenna 104a solely for the transmission of NFC-enabling RF signals, and a second antenna 104b for receiving signals transmitted by the antenna 204 of the payment card 200. In alternative examples, the antenna 104 may be configured to receive signals transmitted by an RFID-enabled payment card 200. The antenna 104 of the payment terminal 100 may be configured to receive RF signals transmitted by the RFID-enabled payment card 200 from farther than 4 centimeters, such as several meters.

As shown in FIG. 2, the card insertion slot 102 is positioned proximate to the antenna 104 such that, in certain circumstances, the insertion of the payment card 200 into the card insertion slot 102 may inadvertently trigger a contactless payment due to the antenna 104 retrieving the card information 206 of the payment card 200 prior to the initiation of a contact payment. Due to the size of the payment terminal 100 and the arrangement of components, it will be difficult to prevent these inadvertent contactless payments by simply physically distancing the card insertion slot 102 from the antenna 104.

As previously described, FIG. 3 illustrates an example payment card 200, such as the payment card 200 placed in the card insertion slot 102 of FIG. 2. The payment card 200 may be any type of card used to facilitate payments, such as a credit card, debit card, gift card, pre-paid cash card, etc. In the example of FIG. 3, the payment card 200 includes a chip 202 for use in contact payments. The chip 202 stores card information 206, such as a personal account number (PAN), a customer verification value (CVV), an expiration date, etc. The payment card 200 further includes an antenna 204 for use in contactless payments. The antenna 204 is used to transmit the card information 206 in NFC or RFID applications. In some examples, the payment card 200 is configured as a dual-interface card such that the antenna 204 is embedded within the chip 202.

FIG. 4 shows a cross-sectional view of the payment terminal 100. The cross-sectional view shows various layers of the payment terminal 100, including an antenna 104, a card insertion slot 102, and a lower housing 120b. As previously described, a multi-layered electromagnetic shield 106 is used to isolate the antenna 104 from the card insertion slot 102 to prevent the triggering of a contactless payment when a payment card 200 is inserted into the card insertion slot 102. The electromagnetic shield 106 includes a ferrite layer 108. The ferrite layer 108 is arranged adjacent to and underneath the antenna 104. In some examples, the ferrite layer 108 is at least partially comprised of aluminum. Alternatively, the ferrite layer 108 may include any other type of applicable ferrite material.

The electromagnetic shield 106 also includes a paramagnetic metal layer 110. The paramagnetic metal layer 110 is arranged below the ferrite layer 108. In some examples, the paramagnetic metal layer 110 is at least partially comprised of stainless steel. Alternatively, the paramagnetic metal layer 110 may include any other type of applicable paramagnetic material. Further, the paramagnetic layer 110 is separated from the ferrite layer 108 by a gap 112. In some examples, the gap 112 may be approximately 2 millimeters. Further, FIG. 4 shows a horizontal portion of the paramagnetic metal layer 110 which is parallel to the ferrite layer 108 and the antenna 104.

Experimental testing has shown that arranging solely a ferrite layer 108 or a paramagnetic metal layer 110 as an isolator at the card insertion slot 102 or the antenna 104 fails to provide sufficient isolation while also enabling the antenna 104 to receive and transmit RF signals per EMV standards. Accordingly, the arrangement of FIG. 4 solves this problem by positioning the multi-layer electromagnetic shield 106 proximate to the antenna 104 to suppress coupling between the card insertion slot 102 and the antenna 104. The ferrite layer 108 compensates for transmission and reception power loss of the antenna 104, while the paramagnetic metal layer 110 further suppresses magnetic leakage through the ferrite layer 108. The balance between the isolation between the card insertion slot 102 and the antenna 104 and the transmission and reception power of the antenna 104 can be adjusted by configuring (tuning) the size of the gap 112. Narrowing the gap 112 increases the isolation between the antenna 104 and the card insertion slot 102, but it also reduces the antenna power, potentially below EMV standards for a contactless payment. Widening the gap 112 increases antenna power, but it also reduces the isolation between the card insertion slot 102 and the antenna 104, potentially allowing for the triggering of contactless payments when payment card 200 (see FIG. 3) is inserted into the card insertion slot 102. An optimum size of the gap 112 for a specific arrangement of the card insertion slot 102, the antenna 104, and the electromagnetic shield 106 may be determined via computer simulation and/or experimental laboratory testing. The optimum size of the gap 112 may also depend on the properties of the materials chosen for the ferrite layer 108 and the paramagnetic metal layer 110.

The card insertion slot 102 of FIG. 4 sits upon and/or electrically couples to a printed circuit board (PCB) 122. Further, the card insertion slot 102 is surrounded by a plastic bunker 132 and a light guide 128.

In the example of FIG. 4, the antenna 104 is arranged to the upper left of the card insertion slot 102. However, the shielding techniques disclosed herein are not limited to only the arrangement shown in FIG. 4. In further examples, the antenna 104 may be arranged above or below the card insertion slot 102 with the electromagnetic shield 106 (including the paramagnetic metal layer 110 and the ferrite layer 108 separated by the gap 112) arranged between the antenna 104 and the card insertion slot 102.

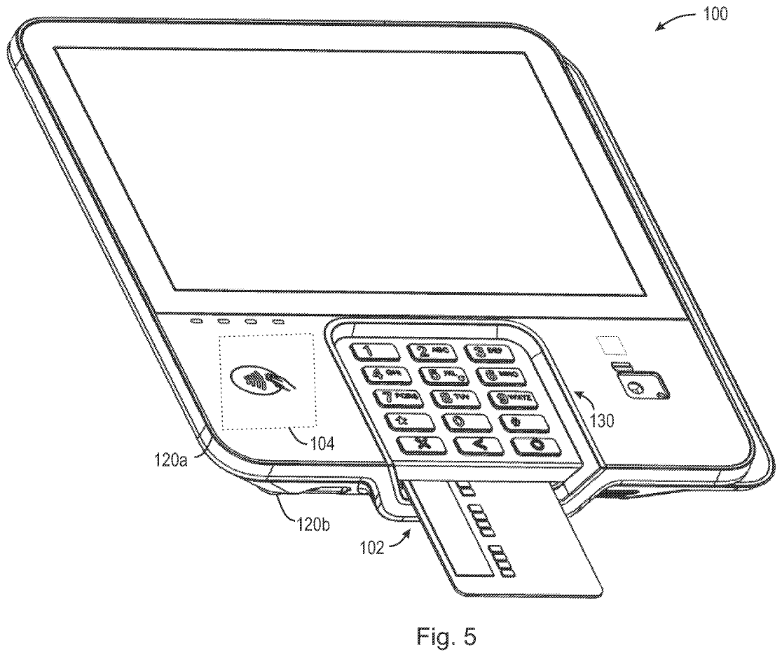

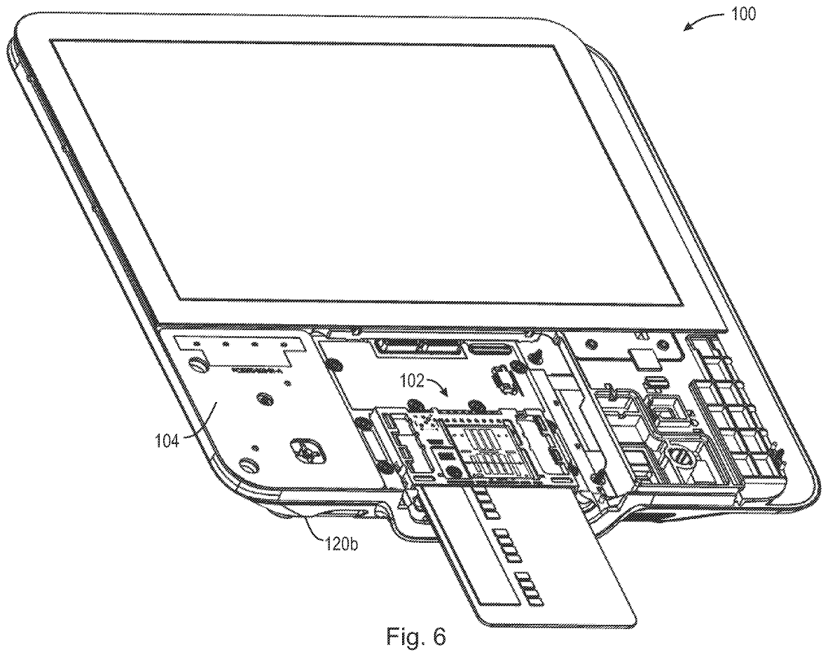

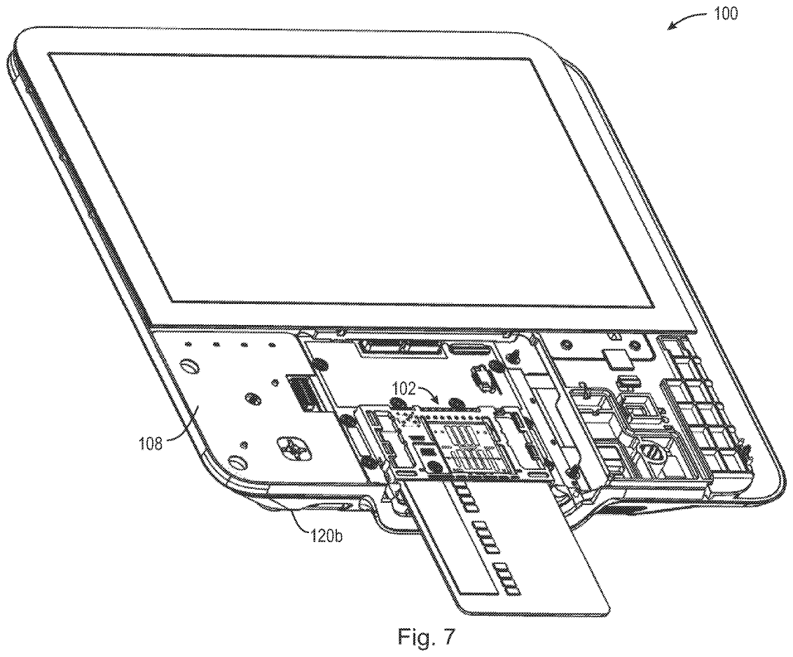

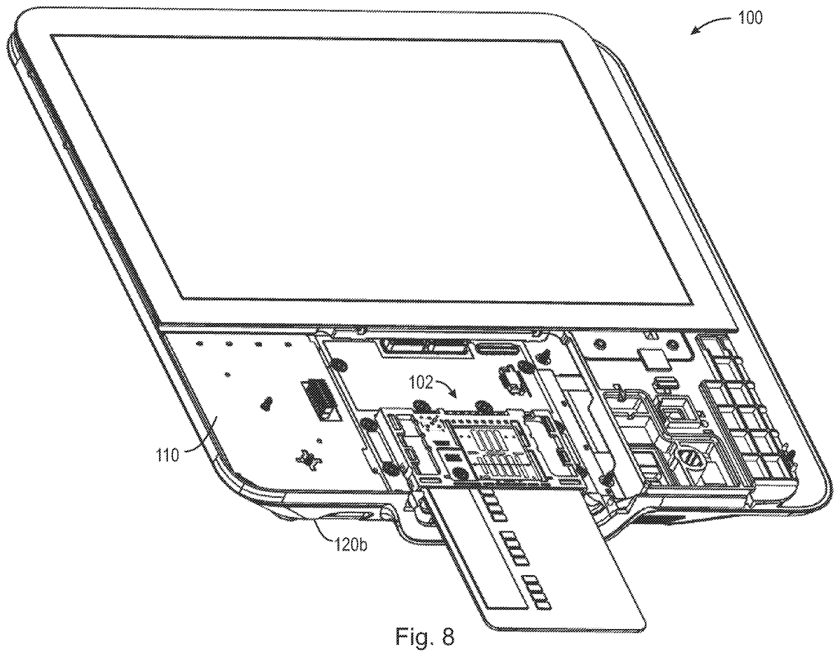

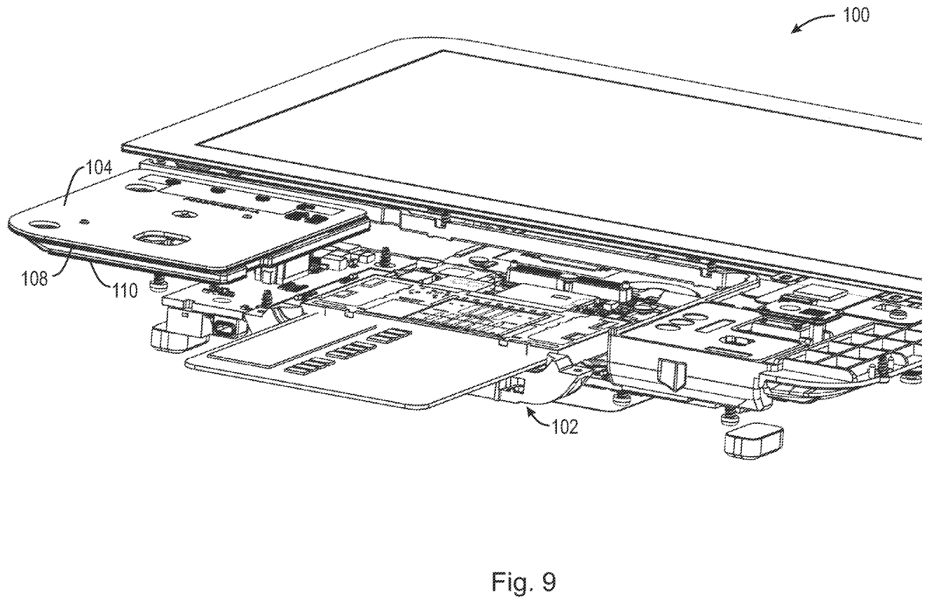

FIGS. 5-9 are isometric views showing various components of a payment terminal 100. As previously discussed, the payment terminal 100 of FIG. 5 includes a card insertion slot 102, an antenna 104, an upper housing 120a, a lower housing 120b, and a keypad 130. In particular, the antenna 104 is arranged below the upper housing 120a. FIG. 6 shows the payment terminal of FIG. 5 with the upper housing 120a removed, exposing the card insertion slot 102 and the antenna 104. FIG. 7 shows the payment terminal of FIGS. 5 and 6 with the antenna 104 removed, exposing the ferrite layer 108 of the electromagnetic shield 106. FIG. 8 shows the payment terminal of FIGS. 5-7 with the antenna 104 removed, exposing the paramagnetic metal layer 110 of the electromagnetic shield 106. FIG. 9 shows a different isometric view of the payment terminal 100 of FIG. 6 with both the upper and lower housings 120a, b removed to expose the antenna 104, the ferrite layer 108, and the paramagnetic metal layer 110.

FIG. 10 is a functional block diagram of a payment terminal 100. The payment terminal 100 includes a card insertion slot 102, an antenna 104, a processor 114, a transceiver 150, and a memory 175. The card insertion slot 102 and the antenna 104 are configured to capture card information 206 from a payment card 200. The card insertion slot 102 transmits card information 206 captured from a chip 202 on the payment card 200 (see FIG. 3) to the processor 114. Similarly, the antenna 104 of the payment terminal 100 transmits card information 206 wirelessly received (such as via NFC or RFID protocols) from the payment card 200 to the processor 114 via the transceiver 150. The processor 114 may then provide the card information 206 or processed versions of the card information 206 to the memory 175 for storage.

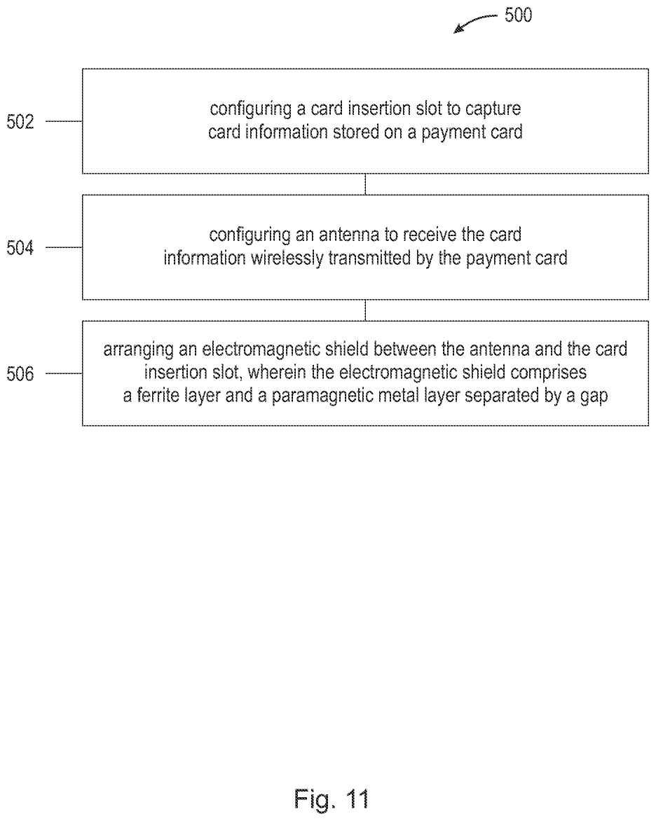

FIG. 11 is a flowchart of a method 500 for manufacturing a payment terminal 100. The method 500 includes configuring 502 a card insertion slot to capture card information stored on a payment card. The card insertion slot may be configured to capture the card information from a chip embedded in the payment card.

The method 500 further includes configuring 504 an antenna to receive card information wirelessly transmitted by the payment card. According to an example, the antenna is an NFC antenna.

The method 500 further includes arranging 506 an electromagnetic shield between the antenna and the card insertion slot. The electromagnetic shield includes a ferrite layer and a paramagnetic metal layer separated by a gap. The gap separating the ferrite layer from the paramagnetic metal layer may be approximately 2 millimeters. According to an example, the ferrite layer may be thinner than the gap. Further, the paramagnetic metal layer may also be thinner than the gap.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A payment terminal, comprising:
a card insertion slot configured to capture card information stored on a payment card;
an antenna configured to receive the card information wirelessly transmitted by the payment card; and
an electromagnetic shield arranged between the antenna and the card insertion slot, wherein the electromagnetic shield comprises a ferrite layer and a paramagnetic metal layer separated by a gap.

2. The payment terminal of claim 1, wherein the ferrite layer is adjacent to the antenna.

3. The payment terminal of claim 1, wherein the gap separating the ferrite layer from the paramagnetic metal layer is approximately 2 millimeters.

4. The payment terminal of claim 1, wherein the ferrite layer is thinner than the gap.

5. The payment terminal of claim 1, wherein the paramagnetic metal layer is thinner than the gap.

6. The payment terminal of claim 1, wherein the ferrite layer comprises aluminum.

7. The payment terminal of claim 1, wherein the paramagnetic metal layer comprises stainless steel.

8. The payment terminal of claim 1, wherein the antenna is a near field communication (NFC) antenna.

9. The payment terminal of claim 1, wherein the card insertion slot is configured to capture the card information from a chip embedded in the payment card.

10. The payment terminal of claim 1, wherein the payment card is a dual interface card.

11. The payment terminal of claim 1, further comprising a processor configured to receive the card information from the card insertion slot or the antenna.

12. The payment terminal of claim 1, wherein the card insertion slot is arranged proximate to the antenna.

13. The payment terminal of claim 1, wherein at least a portion of the ferrite layer is parallel to at least a portion of the paramagnetic metal layer.

14. The payment terminal of claim 1, wherein a reference coupling measured between the card insertion slot and the antenna is less than or equal to eight millivolts.

15. A method for manufacturing a payment terminal, comprising:
configuring a card insertion slot to capture card information stored on a payment card;
configuring an antenna to receive the card information wirelessly transmitted by the payment card; and
arranging an electromagnetic shield between the antenna and the card insertion slot, wherein the electromagnetic shield comprises a ferrite layer and a paramagnetic metal layer separated by a gap.

16. The method of claim 15, wherein the gap separating the ferrite layer from the paramagnetic metal layer is approximately 2 millimeters.

17. The method of claim 15, wherein the antenna is a near field communication (NFC) antenna.

18. The method of claim 15 wherein the card insertion slot is configured to capture the card information from a chip embedded in the payment card.

19. The method of claim 15, wherein the ferrite layer is thinner than the gap.

20. The method of claim 15, wherein the paramagnetic metal layer is thinner than the gap.
